(19) United States
(12) Patent Application Publication
(10) Pub. No.: US 2024/0387959 A1
(43) Pub. Date: Nov. 21, 2024

(54) BATTERY WITH IMPROVED ENERGY DENSITY

(71) Applicant: Apple Inc., Cupertino, CA (US)

(72) Inventors: Akshaya K Padhi, Sunnyvale, CA (US); Nalini P Subramanian, Santa Clara, CA (US); Tong Xie, Campbell, CA (US)

(21) Appl. No.: 18/645,119

(22) Filed: Apr. 24, 2024

Related U.S. Application Data
(60) Provisional application No. 63/466,500, filed on May 15, 2023.

(51) Int. Cl. H01M 50/538; H01M 50/586

(52) U.S. Cl. CPC H01M 50/538; H01M 50/586

(57) ABSTRACT

The present disclosure is directed to a battery including an anode and a cathode. The anode may include an anode current collector and anode active material disposed on the anode current collector, the anode active material forming an anode body and an anode neck extending from an anode surface of the anode body. Moreover, the anode current collector may include an anode current collector tab extending away from the anode neck. The cathode may include a cathode active material disposed on a portion of a cathode current collector, the cathode active material forming a cathode body and a cathode neck extending from a cathode surface of the cathode body. The cathode neck may overlap with the anode neck.

### CROSS-REFERENCE TO RELATED APPLICATIONS

This application claims priority to U.S. Provisional Application No. 63/466,500, filed May 15, 2023, entitled “BATTERY WITH IMPROVED ENERGY DENSITY,” the disclosure of which is incorporated herein in its entirety for all purposes.

### BACKGROUND

The present disclosure relates generally to battery electrodes. More specifically, the present disclosure relates to increasing an electrical power storage capacity and/or energy density of a battery based on battery electrode geometries.

A battery may be formed by one or more anodes, one or more cathodes, one or more separators, electrolyte, a housing, terminals, and other possible componentry. An anode of the battery may include anode active material (e.g., coated on an anode current collector), and a cathode of the battery may include cathode active material (e.g., coated on a cathode current collector) to store electrical power. An electrical power storage capacity and/or energy density of the battery may be a function of an amount (e.g., volume, surface area) of the cathode active material and/or an amount of the anode active material. Electrical power storage capacity and/or energy density of traditional battery configurations may be limited by the amount of cathode active material and/or the amount of anode active material in the battery. Accordingly, improved battery systems and methods are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a battery includes an anode including an anode current collector and an anode active material disposed on a portion of the anode current collector. The anode active material forms an anode body and an anode neck extending from an anode surface of the anode body. An anode current collector tab of the anode current collector extends away from the anode neck. The battery may also include a cathode including a cathode current collector and a cathode active material disposed on a portion of the cathode current collector, the cathode active material forming a cathode body and a cathode neck extending from a cathode surface of the cathode body. The cathode neck may overlap with the anode neck.

In another embodiment, an electrode assembly of a battery includes an anode including an anode current collector and an anode active material disposed on a portion of the anode current collector. The anode active material forms an anode body and an anode neck extending from an anode surface of the anode body. The anode current collector includes an anode current collector tab extending away from the anode neck. The electrode assembly may also include a cathode including a cathode current collector and a cathode active material disposed on a portion of the cathode current collector, the cathode active material forming a cathode body and a cathode neck extending from a cathode surface of the cathode body. The cathode neck may overlap with the anode neck. Moreover, the cathode current collector may include a cathode current collector tab extending away from the cathode neck or an additional cathode neck of the cathode.

In yet another embodiment, a cathode includes a cathode current collector and a cathode body including a cathode active material disposed on a portion of the cathode current collector. The cathode may include a first cathode neck including the cathode active material disposed on the portion of the cathode current collector. Moreover, the cathode may include a second cathode neck including the cathode active material disposed on the portion of the cathode current collector, where the first cathode neck and the second cathode neck are separated by a gap. Moreover, the cathode current collector may include a cathode current collector tab extending away from the second cathode neck.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a perspective view of a battery employed to power the electronic device of FIG. 1, according to embodiments of the present disclosure;

FIG. 3 is a cross-sectional front view of a portion of the battery of FIG. 2, including a cathode neck of a cathode of the battery aligned with (e.g., overlapping) an anode neck of an anode of the battery, where an anode tab corresponding to an anode current collector of the anode extends from the anode neck and includes a width substantially equal to that of the anode neck, according to embodiments of the present disclosure;

FIG. 4 is a cross-sectional front view of a portion of the battery of FIG. 2, including a cathode neck of a cathode of the battery aligned with (e.g., overlapping) an anode neck of an anode of the battery, where an anode tab corresponding to an anode current collector of the anode extends from the anode neck and includes a width smaller than that of the anode neck, according to embodiments of the present disclosure;

FIG. 5 is a cross-sectional front view of a portion of the battery of FIG. 2, including an extended cathode neck of a cathode of the battery aligned with (e.g., overlapping) an extended anode neck of an anode of the battery, according to embodiments of the present disclosure; and

FIG. 6 is a process flow diagram illustrating a manufacturing process of the battery of any of FIGS. 2-5, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

The present disclosure is directed to a battery with improved power storage capacity (e.g., electrical power storage capacity) and/or energy density. In particular, the present disclosure describes a battery with additional cathode active material and/or additional anode active material (e.g., relative to traditional configurations) to improve the power storage capacity and/or the energy density of the battery. In some embodiments, the battery may include the additional cathode active material and/or the additional anode active material without an increased volume or footprint of the battery relative to traditional configurations. As such, the battery may store and provide an increased amount of electrical power relative to traditional configurations and without an increased volume or footprint. That is, presently disclosed batteries may include improved energy density over traditional configurations, as described in detail below with reference to the drawings.

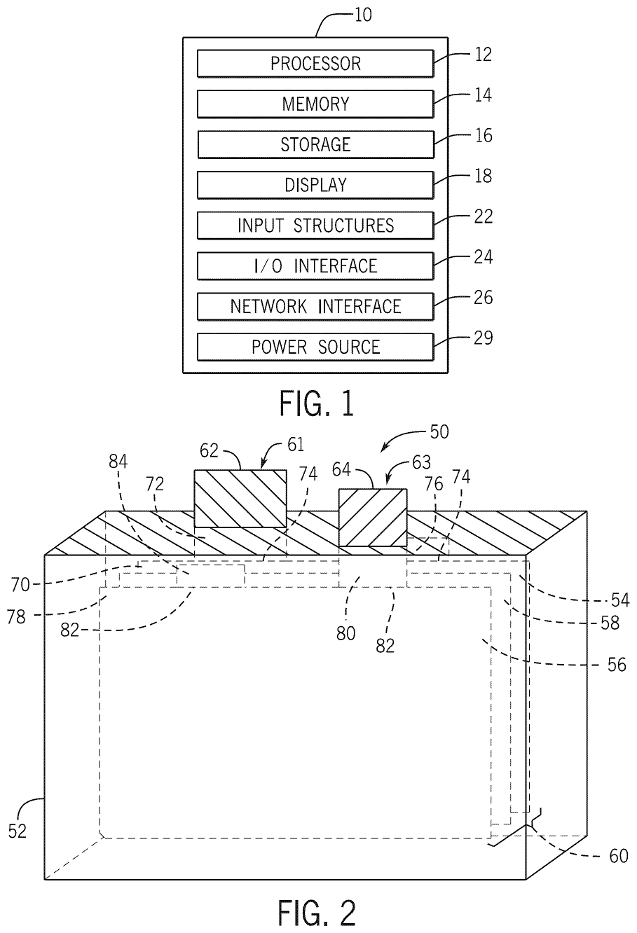

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive data between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, long term evolution (LTE®) cellular network, long term evolution license assisted access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth). The power source 29 of the electronic device 10 may include any suitable source of power, such as a rechargeable lithium polymer (Li-poly) battery and/or an alternating current (AC) power converter.

In accordance with the present disclosure, and as described in detail below with reference to later drawings, a battery (e.g., corresponding to the power source 29) of the electronic device 10 may include a housing, at least one anode disposed in the housing, and at least one cathode disposed in the housing, among other features. The cathode may include one or more cathode necks formed by cathode active material, and the anode may include one or more anode necks formed by anode active material, where the cathode neck(s) and/or the anode neck(s) improve an energy density of the battery relative to traditional configurations. These and other features are described in detail below with reference to FIGS. 2-6. It should be noted that the batteries described in detail below with reference to FIGS. 2-6 may be employed in the electronic device 10 of FIG. 1 and/or in other battery powered applications, such as batteries employed in electrical vehicle (EV) applications, other consumer electronic devices, etc. That is, presently disclosed batteries are not limited for use in the electronic device 10 of FIG. 1, and may be employed in any battery powered application.

FIG. 2 is a block diagram of a battery 50 of the electronic device 10 discussed above with respect to FIG. 1 (e.g., where the battery 50 corresponds to the power source 29). The battery 50 may include a battery housing 52, an anode 54, a cathode 56, and a separator 58. Although the battery housing 52 is depicted as a rectangular prism in FIG. 2, it should be appreciated that in alternative or additional embodiments, the battery housing 52 may have any other viable form. Indeed, in certain embodiments, the battery housing 52 may be a pouch, casing, or the like that is pinched or otherwise closed around the anode(s) 54, the cathode(s) 56, and the separator(s) 58 of the battery 50. The anode 54, the cathode 56, and the separator 58 may be referred to as an electrode assembly 60 of the battery 50.

The anode 54 (e.g., a single anode) may include an anode current collector 61 having an anode tab 62 (e.g., an anode current collector tab), and the cathode 56 (e.g., a single cathode) may include a cathode current collector 63 having a cathode tab 64 (e.g., a cathode current collector tab). In the illustrated embodiment, only the anode tab 62 of the anode current collector 61 is shown, and only the cathode tab 64 of the cathode current collector 63 is shown. For example, other portions of the anode current collector 61 and the cathode current collector 63 may be coated or otherwise covered by anode active material and cathode active material, respectively. In other words, the anode tab 62 of the anode current collector 61 may be exposed while other portions of the anode current collector 61 are coated or otherwise covered in anode active material, and the cathode tab 64 of the cathode current collector 63 may be exposed while other portions of the cathode current collector 63 are coated or otherwise covered in cathode active material. The separator 58 (e.g., a single separator) is depicted as being disposed between the anode 54 and the cathode 56. For example, the anode 54, the cathode 56, and the separator 58 may be stacked and/or coupled together by any viable means.

In alternative or additional embodiments, the battery 50 may include multiple additional anodes, multiple additional cathodes, and multiple additional separators not shown for simplicity. For example, the multiple additional anodes, the multiple additional cathodes, and the multiple additional separators may be stacked and/or coupled in any viable form and/or order. In certain embodiments, each anode 54 may include an instance of the anode tab 62 and each cathode 56 may include an instance of the cathode tab 64, where the various anode tabs 62 are coupled to a first terminal of the battery 50 and the various cathode tabs 64 are coupled to a second terminal of the battery 50. Because the illustrated embodiment only includes one instance of the anode 54 and one instance of the cathode 56, the anode tab 62 of the anode current collector 61 may act as a first terminal of the battery 50, and the cathode tab 64 of the cathode current collector 63 may act as a second terminal of the battery 50. However, it should be understood that multiple instances of the anode tab 62 (e.g., corresponding to multiple instances of the anode 54) and multiple instances of the cathode tab 64 (e.g., corresponding to multiple instances of the cathode 56) may be employed in other embodiments.

In any case, the anode 54 is disposed on a first side of the separator 58 and the cathode 56 is disposed on a second side of the separator 58. The anode 54 may include anode active material, as previously described, that contributes to the electrochemical processes for storing energy or power. In some embodiments, the anode active material is coated or otherwise disposed on a portion of the anode current collector 61 such that the anode tab 62 of the anode current collector 61 is exposed (e.g., uncoated or uncovered by the anode active material). The anode 54 may have an anode body 70 and a first anode neck 72 (e.g., an anode neck) extending from an anode surface 74 of the anode body 70. For example, the anode body 70 may have a first anode rectangular shape (e.g., cross-section) including or formed by a portion of the anode active material. Moreover, the first anode neck 72 may have a second anode rectangular shape (e.g., cross-section) including or formed by a portion of the anode active material. The second anode rectangular shape may extend from a first portion of the anode surface 74 of the first anode rectangular shape.

The anode tab 62 may extend upwardly (e.g., away) from the first anode neck 72 of the anode 54. Indeed, as previously described, the anode active material may be coated on a portion of the anode current collector 61, where the anode tab 62 extends from said coated portion of the anode current collector 61. The anode tab 62 may act as an electrical conductor between the anode 54 and external circuits. In particular, the anode tab 62 may input and/or output at least a portion of the electrical power or current between the anode 54 and external circuits. The external circuits may include the processor 12, the memory 14, the storage 16, the display 18, the input structures 22, the I/O interface 24, or the network interface 26 discussed above with respect to FIG. 1, or any combination thereof, among other things.

The anode 54 may also have a second anode neck 76 (e.g., an additional anode neck) extending from the anode surface 74 of the anode body 70. The second anode neck 76 may include a third anode rectangular shape (e.g., cross-section) including or formed by a portion of the anode active material. The third anode rectangular shape may extend from a second portion of the anode surface 74 of the first anode rectangular shape.

The cathode 56 may include cathode active material, as previously described, that contributes to the electrochemical processes for storing energy or power. In some embodiments, the cathode active material is coated or otherwise disposed on a portion of the cathode current collector 63 such that the cathode tab 64 of the cathode current collector 63 is exposed (e.g., uncoated by the cathode active material). The cathode 56 may have a cathode body 78 and a first cathode neck 80 (e.g., an additional cathode neck) extending from a cathode surface 82 of the cathode body 78. For example, the cathode body 78 may have a first cathode rectangular shape (e.g., cross-section) including or formed by the cathode active material. Similarly, the first cathode neck 80 may have a second cathode rectangular shape (e.g., cross-section) including or formed by the cathode active material. The second cathode rectangular shape may extend from a first portion of the cathode surface 82 of the first cathode rectangular shape.

The cathode tab 64 may extend upwardly (e.g., away) from the first cathode neck 80 of the cathode 56. The cathode tab 64 may act as an electrical conductor between the cathode 56 and the external circuits. In particular, the cathode tab 64 may input and/or output at least a portion of the electrical power or current between the cathode 56 and external circuits. As mentioned above, the external circuits may include the processor 12, the memory 14, the storage 16, the display 18, the input structures 22, the I/O interface 24, or the network interface 26 discussed above with respect to FIG. 1, or any combination thereof, among other things.

The cathode 56 may also include a second cathode neck 84 (e.g., a cathode neck) extending from the cathode surface 82 of the cathode body 78. The second cathode neck 84 may include a third cathode rectangular shape (e.g., cross-section) including or formed by the cathode active material. The third cathode rectangular shape may extend from a second portion of the cathode surface 82 of the first cathode rectangular shape. Accordingly, the battery 50 may include additional cathode active material based on having the second cathode neck 84, thereby having improved power storage capacity. It should be noted that, in some embodiments, the first cathode neck 80 and/or the second cathode neck 84 may include cathode active material coated or otherwise disposed on the cathode current collector 63. Likewise, the first anode neck 72 and/or the second anode neck 76 may include anode active material coated or otherwise disposed on the anode current collector 61.

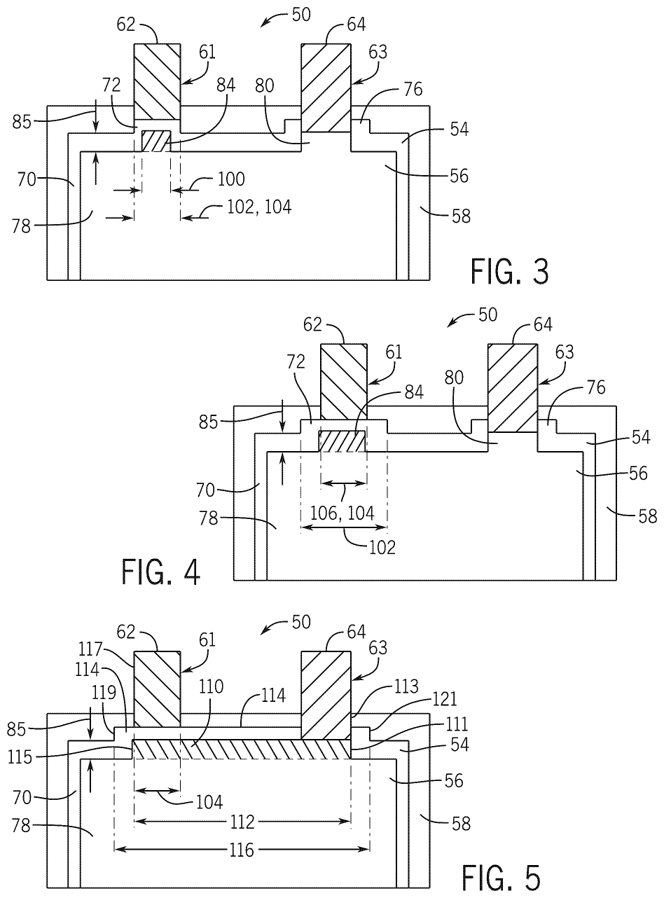

With the foregoing in mind, cross-sections (e.g., rectangular cross-sections) of the cathode 56 may align with (e.g., overlap) the anode 54 across the separator 58, as will be appreciated in view of the discussion below with reference to FIGS. 3-5. Although examples of rectangular shapes for the anode body 70, the first anode neck 72, the second anode neck 76, the cathode body 78, the first cathode neck 80, and the second cathode neck 84 are described in accordance with the present disclosure, it should be appreciated that in alternative or additional embodiments, any of such components of the battery 50 may have any other viable shapes. Moreover, any rectangular component described herein may have substantially rectangular or near rectangular shape.

FIGS. 3-5 depict cross-sectional front views of different embodiments of portions of the battery 50 of FIG. 2. As mentioned above, certain aspects (e.g., certain rectangular cross-sections) of the cathode 56 may align with (e.g., overlap) certain aspects (e.g., certain rectangular cross-sections) of the anode 54 across the separator 58. For example, the anode body 70, the first anode neck 72, and the second anode neck 76 may be overhanging the cathode body 78, the second cathode neck 84, and the first cathode neck 80, respectively, across the separator 58. A portion 85 of the anode body 70 extending outside of a boundary of the cathode 56 may be referred to as an anode/cathode overhang. The portion 85 (e.g., anode/cathode overhang) may be maintained to ensure safe, reliable performance of the battery 50.

In the depicted embodiments, the cross-sectional front views of FIGS. 3-5 depict the cathode 56 being in front of the separator 58 and the anode 54. Moreover, the cross-section views depict a portion of the separator 58, which is generally disposed between the anode 54 and the cathode 56. The depicted portions of the anode 54, which in practice are disposed behind the separator 58 such that the separator 58 is between the anode 54 and the cathode 56, are being shown through the separator 58 for visibility.

In any case, FIG. 3 depicts a first embodiment of the battery 50. In the first embodiment, the second cathode neck 84 includes a first cathode neck width 100 smaller than a first anode neck width 102 of the first anode neck 72, and smaller than an anode tab width 104 of the anode tab 62. Further, the first anode neck width 102 and the anode tab width 104 are substantially equal (e.g., equal, nearly equal, equal within a threshold error range) in FIG. 3. In the first embodiment, the battery 50 may include additional cathode active material based on having the second cathode neck 84 (e.g., compared to traditional batteries). Accordingly, the battery 50 may have improved power storage capacity compared to the traditional batteries.

As previously described, the cathode 56 in FIG. 3 also includes the first cathode neck 80, from which (e.g., away from which) the cathode tab 64 of the cathode current collector 63 extends. The first cathode neck 80 is aligned with (e.g., overlapping) the second anode neck 76 in FIG. 3. In other words, the first cathode neck 80 is aligned with (e.g., overlapping) the second anode neck 76, and the second cathode neck 84 is aligned with (e.g., overlapping) the first anode neck 72. In this way, the various necks 72, 76, 80, 84 are consolidated to two locations of the battery 50 (e.g., the two locations corresponding to the two locations of the anode tab 62 of the anode current collector 61 and the cathode tab 64 of the cathode current collector 63). In this way, an amount of anode active material and cathode active material is improved over traditional configurations, without substantially increasing a volume or footprint of the battery 50, thereby improving energy density of the battery 50 over traditional configurations. Indeed, a housing (not shown) of the battery 50 may be sealed along a perimeter of the battery 50, leaving space for the anode tab 62 to extend therethrough and the cathode tab 64 to extend therethrough. By placing the necks 72, 76, 80, 84 in a location proximate to the anode tab 62 and the cathode tab 64, the above-described space, which otherwise may include some empty space, is filled with active material of the anode 54 and the cathode 56. In this way, energy density of the battery 50 is improved, as a footprint of the battery 50, which may be defined mostly or entirely by the housing of the battery 50, remains unchanged, while an amount of active material is increased.

FIG. 4 depicts a second embodiment of the battery 50. In the second embodiment, the second cathode neck 84 may have a second cathode neck width 106 substantially equal (e.g., equal, nearly equal, equal within a threshold error range) to the anode tab width 104 of the anode tab 62, and smaller than the first anode neck width 102 of the first anode neck 72. In the second embodiment, the battery 50 may include additional cathode active material based on having the second cathode neck 84, and additional anode active material based on an increased size of the width 102 of the anode neck 72. Accordingly, a power storage capacity and/or energy density of the battery 50 is improved compared to traditional configurations.

Similar to FIG. 3 described above, the cathode 56 in FIG. 4 also includes the first cathode neck 80, from which the cathode tab 64 of the cathode current collector 63 extends. The first cathode neck 80 is aligned with (e.g., overlapping) the second anode neck 76 in FIG. 4, similar to FIG. 3. In other words, the first cathode neck 80 is aligned with (e.g., overlapping) the second anode neck 76, and the second cathode neck 84 is aligned with (e.g., overlapping) the first anode neck 72. In this way, the various necks 72, 76, 80, 84 are consolidated to two locations of the battery 50 (e.g., the two locations corresponding to the two locations of the anode tab 62 of the anode current collector 61 and the cathode tab 64 of the cathode current collector 63). In this way, an amount of anode active material and cathode active material is improved over traditional configurations, without substantially increasing a volume or footprint of the battery 50, thereby improving energy density of the battery 50 over traditional configurations.

FIG. 5 depicts a third embodiment of the battery 50. In the third embodiment, the cathode 56 may have an extended cathode neck 110 (e.g., a single cathode neck) that extends across the cathode body 78. For example, the extended cathode neck 110 may extend from the cathode surface 82 of the cathode body 78 discussed above. In the depicted embodiment, a first side 111 of the extended cathode neck 110 may align with (e.g., overlap) or be coupled to a side 113 of the cathode tab 64 of the cathode current collector 63 across the separator 58. Moreover, a second side 115 of the extended cathode neck 110 may align with (e.g., overlap) or be coupled to a side 117 of the anode tab 62 of the anode current collector 61 across the separator 58. The extended cathode neck 110 and the anode tab 62 are disposed on opposing sides of the separator 58.

The extended cathode neck 110 may have a third cathode neck width 112. The battery 50 of the third embodiment may include additional cathode active material based on the extended cathode neck 110 having the third cathode neck width 112 compared to the traditional configurations. Accordingly, the battery 50 of the third embodiment may have an improved power storage capacity and/or energy density based on including the cathode neck 110.

Additionally, the anode 54 may have an extended anode neck 114 (e.g., a single anode neck) being extended across the anode body 70. For example, the extended anode neck 114 may extend from the anode surface 74 of the anode body 70 discussed above. A first side 119 of the extended anode neck 114 may be adjacent to the side 117 of the anode tab 62 and a second side 121 of the extended anode neck 114 may be adjacent to the cathode tab 64 across the separator 58. The extended anode neck 114 and the cathode tab 64 are disposed on opposing sides of the separator 58.

In the depicted embodiment, the battery 50 may include additional anode active material based on an increased area of the anode 54 including the extended anode neck 114. As such, the battery 50 of the third embodiment may include additional anode active material and additional cathode active material compared to the batteries 50 of the first embodiment and the second embodiment. As such, the battery 50 may have improved power storage capacity.

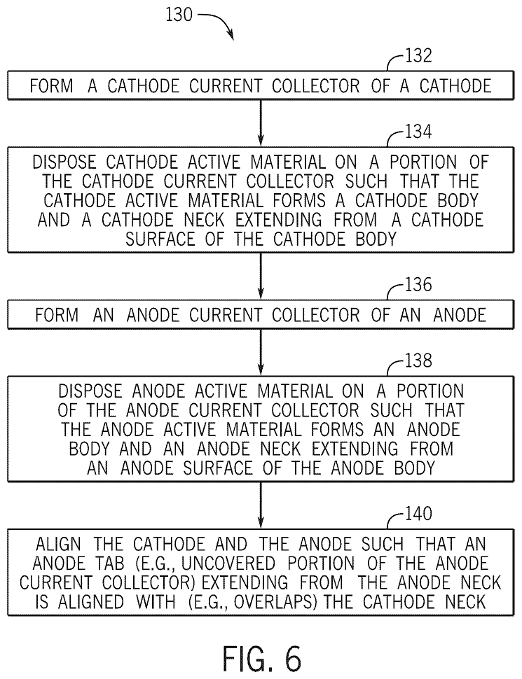

FIG. 6 is a process flow diagram illustrating a manufacturing process 130 for assembling the battery 50 in any of FIGS. 2-5 described above. It should be appreciated that the manufacturing process 130 may be performed in any viable order. Moreover, it should be appreciated that in different embodiments, the manufacturing process 130 may include additional and/or reduced process blocks.

The process 130 includes forming (block 132) a cathode current collector of a cathode. The process 130 also includes disposing (block 134) cathode active material on a portion of the cathode current collector such that the cathode active material forms a cathode body and a cathode neck extending from a cathode surface of the cathode body. In some embodiments, an additional cathode neck may also be formed by the cathode active material, where the additional cathode neck is aligned with a cathode tab of the cathode current collector (e.g., where the cathode tab is a portion of the cathode current collector not covered by the cathode active material).

The process 130 also includes forming (block 136) an anode current collector of an anode, and disposing (block 138) anode active material on a portion of the anode current collector such that the anode active material forms an anode body and an anode neck extending from an anode surface of the anode body. In some embodiments, the anode neck is aligned with an anode tab of the anode current collector (e.g., where the anode tab is a portion of the anode current collector not covered by the anode active material). Further, in some embodiments, an additional anode neck may be formed by the anode active material.

The process 130 also includes aligning (block 140) the cathode and the anode such that the anode tab extending from the anode neck is aligned with (e.g., overlaps) the cathode neck. In embodiments where two cathode necks and two anode necks are employed, the additional cathode neck (e.g., aligned with the cathode tab) may be aligned with the additional anode neck.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112 (f). However, for any claims containing elements designated in any other manner, it is intended that such elements are not to be interpreted under 35 U.S.C. 112 (f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A battery, comprising:
an anode comprising:
an anode current collector;
an anode active material disposed on a portion of the anode current collector, the anode active material forming an anode body and an anode neck extending from an anode surface of the anode body; and
an anode current collector tab of the anode current collector, wherein the anode current collector extends away from the anode neck; and
a cathode comprising a cathode active material disposed on a portion of a cathode current collector, the cathode active material forming a cathode body and a cathode neck extending from a cathode surface of the cathode body, wherein the cathode neck overlaps with the anode neck.

2. The battery of claim 1, wherein the cathode comprises:
an additional cathode neck extending from the cathode surface of the cathode body; and
a cathode current collector tab of the cathode current collector, wherein the cathode current collector tab extends away from the additional cathode neck.

3. The battery of claim 2, wherein the anode comprises an additional anode neck, and the additional anode neck overlaps with the additional cathode neck.

4. The battery of claim 1, wherein the cathode comprises a cathode current collector tab extending away from the cathode neck.

5. The battery of claim 4, wherein:
the anode neck comprises a first anode neck side and a second anode neck side opposing the first anode neck side;
the cathode neck comprises a first cathode neck side and a second cathode neck side opposing the first cathode neck side;
the first anode neck side is positioned adjacent the first cathode neck side;
the second anode neck side is positioned adjacent the second cathode neck side;
the anode current collector tab extends away from the anode neck adjacent to the first anode neck side; and
the cathode current collector tab extends away from the cathode neck adjacent to the second cathode neck side.

6. The battery of claim 1, wherein a first width of the anode neck and a second width of the anode current collector tab are substantially equal.

7. The battery of claim 1, wherein a first width of the anode neck is greater than a second width of the anode current collector tab.

8. The battery of claim 7, wherein a third width of the cathode neck is equal to or less than the second width of the anode current collector tab.

9. The battery of claim 1, wherein:
the anode body comprises a first rectangular cross-section;
the cathode body comprises a second rectangular cross-section, wherein the first rectangular cross-section of the anode body is larger than the second rectangular cross-section of the cathode body.

10. The battery of claim 1, comprising:
a housing; and
a separator, wherein the cathode and the anode are positioned in the housing and on opposing sides of the separator.

11. An electrode assembly of a battery, comprising:
an anode comprising:
an anode current collector;
an anode active material disposed on a portion of the anode current collector, the anode active material forming an anode body and an anode neck extending from an anode surface of the anode body; and
an anode current collector tab of the anode current collector, wherein the anode current collector tab extends away from the anode neck; and
a cathode comprising:
a cathode current collector;
a cathode active material disposed on a portion of the cathode current collector, the cathode active material forming a cathode body and a cathode neck extending from a cathode surface of the cathode body, wherein the cathode neck is configured to overlap with the anode neck; and
a cathode current collector tab of the cathode current collector, wherein the cathode current collector tab extends away from the cathode neck or an additional cathode neck of the cathode.

12. The electrode assembly of claim 11, wherein the cathode comprises the additional cathode neck extending from the cathode surface of the cathode body, the cathode neck and the additional cathode neck are separated by a gap, and the cathode current collector tab extends away from the additional cathode neck.

13. The electrode assembly of claim 12, wherein the anode comprises an additional anode neck, the anode neck and the additional anode neck are separated by an additional gap, and the additional anode neck is configured to overlap with the additional cathode neck.

14. The electrode assembly of claim 11, wherein a width of the anode neck and an additional width of the anode current collector tab are substantially equal.

15. The electrode assembly of claim 11, wherein a width of the anode neck is greater than an additional width of the anode current collector tab.

16. The electrode assembly of claim 11, wherein a width of the cathode neck is equal to or greater than an additional width of the anode current collector tab.

17. The electrode assembly of claim 11, wherein:
the cathode current collector tab extends away from the cathode neck;
the cathode neck is configured to overlap with the anode current collector tab; and
the anode neck is configured to overlap with the cathode current collector tab.

18. A cathode, comprising:
a cathode current collector;
a cathode body comprising a cathode active material disposed on a portion of the cathode current collector;
a first cathode neck comprising the cathode active material disposed on the portion of the cathode current collector;
a second cathode neck comprising the cathode active material disposed on the portion of the cathode current collector, wherein the first cathode neck and the second cathode neck are separated by a gap; and
a cathode current collector tab of the cathode current collector, wherein the cathode current collector tab extends away from the second cathode neck.

19. The cathode of claim 18, wherein the first cathode neck comprises a first width, the second cathode neck comprises a second width, and the second width is greater than the first width.

20. The cathode of claim 19, wherein the cathode current collector tab comprises a third width, the third width is greater than the first width, and the third width is substantially equal to the second width.
